(19) United States
(12) Patent Application Publication
(10) Pub. No.: US 2025/0199391 A1
(43) Pub. Date: Jun. 19, 2025

(54) IMAGE PROJECTION DEVICE

(71) Applicant: KOITO MANUFACTURING CO., LTD., Tokyo (JP)

(72) Inventors: Takanobu TOYOSHIMA, Shizuoka-shi, Shizuoka (JP); Kazuomi MURAKAMI, Shizuoka-shi, Shizuoka (JP)

(73) Assignee: KOITO MANUFACTURING CO., LTD., Tokyo (JP)

(21) Appl. No.: 18/707,308

(22) PCT Filed: Oct. 26, 2022
(86) PCT No.: PCT/JP2022/039859

§ 371 Date: May 3, 2024

(30) Foreign Application Priority Data
Nov. 19, 2021 (JP) 2021-189004

(51) Int. Cl. G03B 21/28

(52) U.S. Cl. CPC G03B 21/28

(57) ABSTRACT

An image projection device is provided that can effectively mitigate a temperature rise of an image radiation unit due to external light while maintaining the quality of a projected image. The image projection device includes an image radiation unit that radiates an image, a reflection-transmission unit that reflects radiation light from the image radiation unit at a front surface and transmits light from a back surface, and an angle-dependent light transmission unit of which transmittance of light in a predetermined polarization plane changes depending on an incidence angle. The angle-dependent light transmission unit is disposed in an optical path of the radiation light from the image radiation unit to the reflection-transmission unit.

### TECHNICAL FIELD

The present invention relates to an image projection device, and particularly relates to an image projection device that reflects radiation light from an image radiation unit so as to reach a viewpoint.

### BACKGROUND ART

Conventionally, an instrument panel that displays icons by lighting has been used as a device that displays various pieces of information inside a vehicle. As the amount of information to be displayed increases, embedding an image display device in the instrument panel or forming the entire instrument panel by the image display device has also been proposed.

However, since the instrument panel is located under a windshield of the vehicle, viewing the information displayed on the instrument panel requires a driver to move his or her line of sight downward while driving, which is not desirable. Therefore, an image projection device, such as a head-up display (hereinafter “HUD”), has been proposed that projects an image onto a windshield such that the driver can read information when viewing a front side of the vehicle.

FIG. 7 is a schematic view showing the configuration of a conventional image projection device. As shown in FIG. 7, the conventional image projection device includes an image radiation unit 1 and free-form surface mirrors 2, 3. In such an image projection device, the image radiation unit 1 radiates radiation light L including an image, and the free-form surface mirrors 2, 3 reflect the radiation light L so as to reach the position of a viewpoint of a driver etc. in such a manner that the image forms in space through a windshield. Thus, the radiation light L having struck the viewpoint of the driver etc. allows the driver etc. to perceive the image as if it were displayed at an image formation position in a depth direction.

However, in the image projection device shown in FIG. 7, when sunlight etc. strikes from an outside as external light Ls, the external light is collected on a surface of the image radiation unit 1 by the free-form surface mirrors 2, 3, so that the image radiation unit 1 may rise in temperature and deteriorate. Therefore, a device has also been proposed in which an image of radiation light L is intermediately formed between a plurality of free-form surface mirrors 2, 3, and a shielding part or an infrared cutoff filter is disposed near an intermediate image formation position to thereby reduce the influence of external light Ls that reaches the image radiation unit from an outside (e.g., see Patent Literature 1).

### CITATION LIST

### Patent Literature

Patent Literature 1: International Publication No. WO 2017/195740

### SUMMARY OF THE INVENTION

### Technical Problem

However, in the structure using the light-shielding part described in Patent Literature 1, it is unavoidable that the external light reaches the image radiation unit from a space for securing an optical path of the radiation light, and thus there is a limit to restricting the incidence of the external light.

Therefore, the present invention has been devised in view of the above-described conventional problem, and an object thereof is to provide an image projection device that can effectively mitigate a temperature rise of an image radiation unit due to external light while maintaining the quality of a projected image.

### Solution to Problem

To solve the above-described problem, an image projection device of the present invention includes an image radiation unit that radiates an image, a reflection-transmission unit that reflects radiation light from the image radiation unit at a front surface and transmits light from a back surface, and an angle-dependent light transmission unit of which transmittance of light in a predetermined polarization plane changes depending on an incidence angle. The angle-dependent light transmission unit is disposed in an optical path of the radiation light from the image radiation unit to the reflection-transmission unit.

This image projection device of the present invention can transmit light (radiation light) from the image radiation unit while cutting off external light by the angle-dependent light transmission unit. Thus, it is possible to provide an image projection device that can effectively mitigate a temperature rise of an image radiation unit due to external light while maintaining the quality of a projected image.

In one aspect of the present invention, the image projection device includes an angle changing unit that changes an angle of the angle-dependent light transmission unit relative to the optical path.

In one aspect of the present invention, the angle-dependent light transmission unit is held while being bent in at least one axis direction.

In one aspect of the present invention, a radius of curvature of the angle-dependent light transmission unit is within a range of 10 mm to 1000 mm.

In one aspect of the present invention, the image projection device includes a polarized light selection unit that transmits polarized light in a transmission axis direction and blocks polarized light orthogonal to the transmission axis direction, and the polarized light selection unit is disposed in the optical path from the angle-dependent light transmission unit to the reflection-transmission unit.

In one aspect of the present invention, the transmission axis direction of the polarized light selection unit corresponds to the predetermined polarization plane.

In one aspect of the present invention, the image projection device includes an intermediate image formation optical unit that is disposed in the optical path from the image radiation unit to the reflection-transmission unit and forms an image of light from the image radiation unit at an intermediate image formation position.

In one aspect of the present invention, the angle-dependent light transmission unit is disposed in the optical path of the radiation light, at a position closer to the reflection-transmission unit than the intermediate image formation position.

### Advantageous Effects of Invention

The present invention can provide an image projection device that can effectively mitigate a temperature rise of an image radiation unit due to external light while maintaining the quality of a projected image.

### BRIEF DESCRIPTION OF THE DRAWINGS

FIG. 1 is a schematic view showing the configuration of an image projection device 100 according to a first embodiment of the present invention;

FIG. 2 is a schematic view showing a positional relationship among optical members in the image projection device 100, with FIG. 2(a) being a side view and FIG. 2(b) being a top view;

FIG. 3 is a schematic view showing radiation light L radiated from an image radiation unit 10 in the image projection device 100 as a light cone, with FIG. 3(a) being a top view and FIG. 3(b) being a side view;

FIG. 4 is a graph showing a relationship between an incidence angle and a reflectance in an angle-dependent light transmission unit 40;

FIG. 5 is a schematic view showing the configuration of an image projection device 110 according to a second embodiment of the present invention;

FIG. 6 is a schematic view showing the configuration of an image projection device 120 according to a third embodiment of the present invention; and

FIG. 7 is a schematic view showing the configuration of a conventional image projection device.

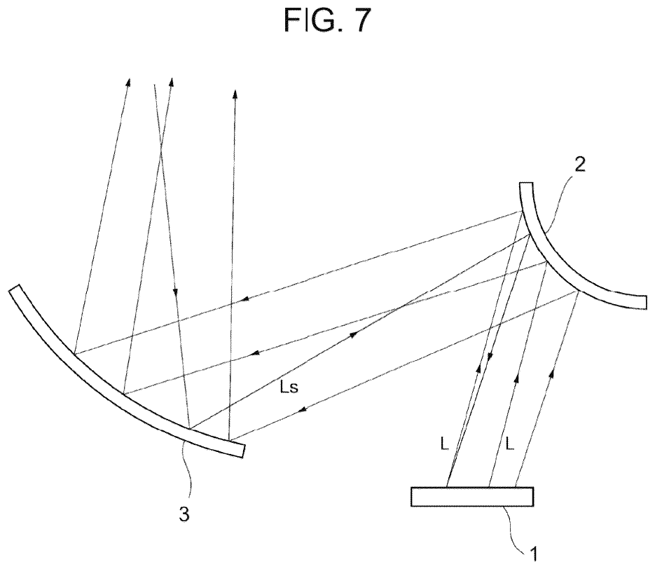

### MODES FOR CARRYING OUT THE INVENTION

### First Embodiment

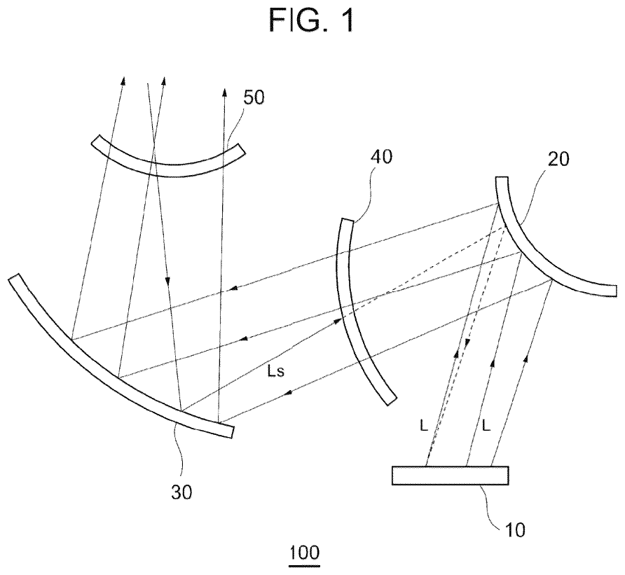

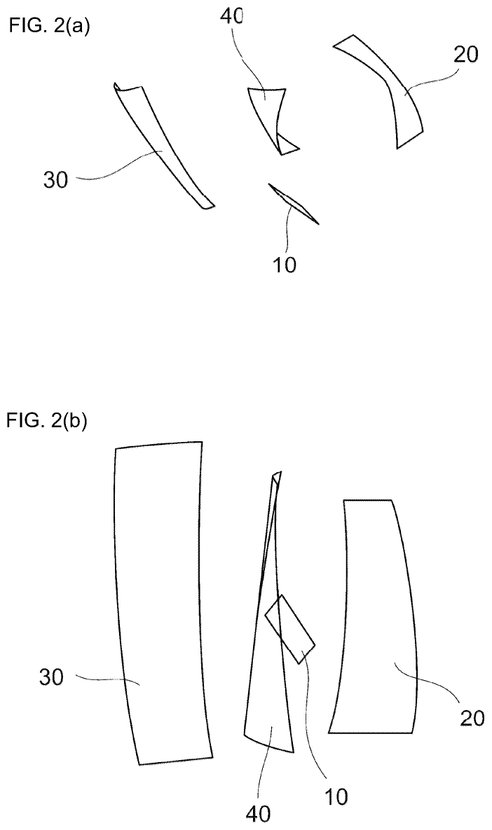

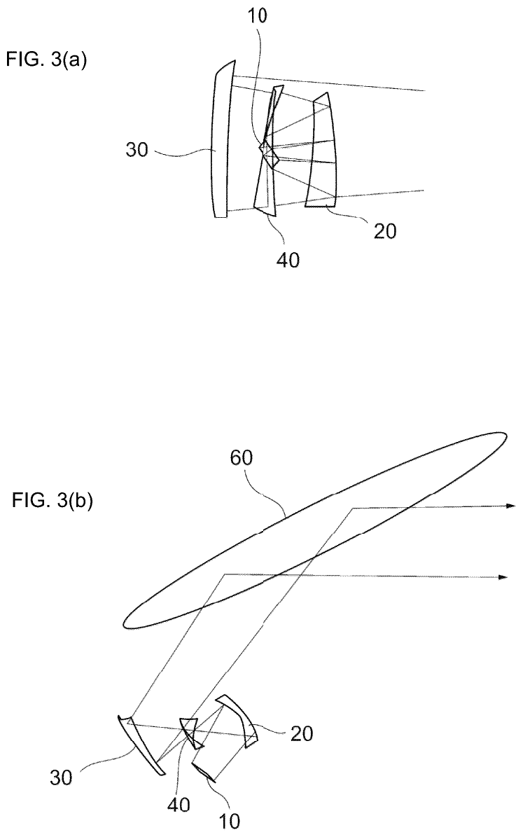

An embodiment of the present invention will be described below in detail with reference to the drawings. Constituent elements, members, and processes shown in the drawings that are the same or equivalent will be denoted by the same reference sign, while overlapping description will be omitted as appropriate. FIG. 1 is a schematic view showing the configuration of an image projection device 100 according to this embodiment. FIG. 2 is a schematic view showing a positional relationship among optical members in the image projection device 100, with FIG. 2(a) being a side view and FIG. 2(b) being a top view. FIG. 3 is a schematic view showing radiation light L radiated from an image radiation unit 10 in the image projection device 100 as a light cone, with FIG. 3(a) being a top view and FIG. 3(b) being a side view.

As shown in FIG. 1 to FIG. 3, the image projection device 100 includes the image radiation unit 10, free-form surface mirrors 20, 30, an angle-dependent light transmission unit 40, and a polarized light selection unit 50. In FIG. 1, representative optical paths of external light Ls, such as sunlight, are indicated by the arrows. As shown in FIG. 3, a windshield 60 of a vehicle is provided outside the image projection device 100, and a driver etc. views an image of the radiation light L from a viewpoint position through the windshield 60.

The image radiation unit 10 is a device that is supplied with a signal including image information from an information processing unit (not shown) and thereby radiates radiation light including the image information. The radiation light radiated from the image radiation unit 10 strikes the free-form surface mirror 20. Examples of the image radiation unit 10 include a liquid crystal display device, an organic EL display device, a micro-LED display device, a digital micro-mirror device (DMD), and a projector device using a laser light source.

The free-form surface mirror 20 is a mirror that the radiation light L radiated from the image radiation unit 10 strikes and that reflects the radiation light L in the direction of the free-form surface mirror 30 through the angle-dependent light transmission unit 40. The shape of a reflection surface of the free-form surface mirror 20 is formed by a free-form surface of which the curvature is not constant but changes two-dimensionally. While a concave mirror is shown as the shape of the free-form surface mirror 20 in FIG. 1, a convex mirror may be used as shown in FIG. 2 and FIG. 3, or a planar mirror may be used.

The free-form surface mirror 30 is a concave mirror that the radiation light L reflected by the free-form surface mirror 20 strikes and that reflects the radiation light L in the direction of the windshield 60 through the polarized light selection unit 50. The shape of a reflection surface of the free-form surface mirror 30 is formed by a free-form surface of which the curvature is not constant but changes two-dimensionally. While a concave mirror is shown as the shape of the free-form surface mirror 30 in FIG. 1, a convex mirror may be used or a planar mirror may be used.

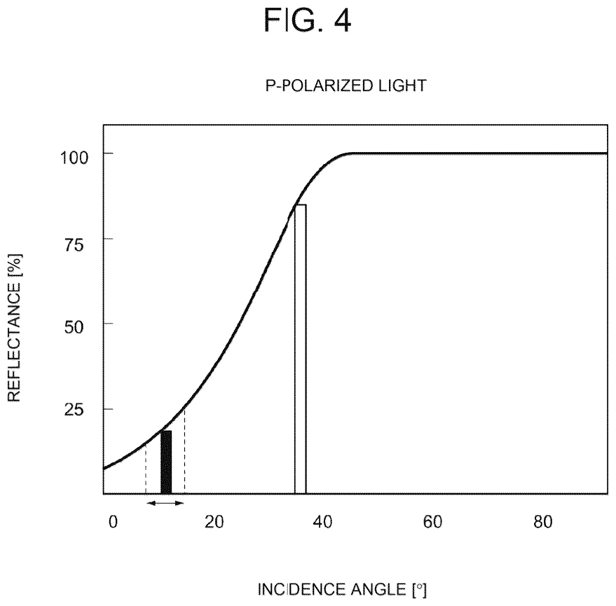

The angle-dependent light transmission unit 40 is an optical member having optical characteristics that the transmittance of light in a predetermined polarization plane (polarization direction) changes depending on an incidence angle. The angle-dependent light transmission unit 40 is disposed between the free-form surface mirror 20 and the free-form surface mirror 30. While the example in which the angle-dependent light transmission unit 40 is disposed between the free-form surface mirror 20 and the free-form surface mirror 30 is shown in FIG. 1 to FIG. 3, the position of the angle-dependent light transmission unit 40 is not limited, as long as it is in the optical path from the image radiation unit 10 to the windshield (reflection-transmission unit) 60 and the radiation light L radiated from the image radiation unit 10 reaches the windshield 60 after being transmitted through the angle-dependent light transmission unit 40. Details of the structure and the optical characteristics of the angle-dependent light transmission unit 40 will be described later using FIG. 4 etc.

The polarized light selection unit 50 is an optical member having optical characteristics of transmitting polarized light in a transmission axis direction and blocking polarized light orthogonal to the transmission axis direction, for which a commonly known polarization plate or polarization film can be used. The polarized light selection unit 50 is disposed between the free-form surface mirror 30 and the windshield 60. While the example in which the polarized light selection unit 50 is disposed between the free-form surface mirror 30 and the windshield 60 is shown in FIG. 1 to FIG. 3, the position of the polarized light selection unit 50 is not limited as long as it is in the optical path of the radiation light L from the angle-dependent light transmission unit 40 to the windshield 60. A transmission axis of the polarized light selection unit 50 is disposed so as to transmit S-polarized light relative to the windshield 60. The transmission axis direction of the polarized light selection unit 50 corresponds to a bending direction of the angle-dependent light transmission unit 40, and corresponds to S-polarized light relative to the windshield 60. While the example in which the polarized light selection unit 50 is provided to transmit only polarized light corresponding to the bending direction of the angle-dependent light transmission unit 40 is shown in FIG. 1, a configuration in which the polarized light selection unit 50 is not provided may be adopted.

The windshield 60 is provided on a front side of a driver's seat of the vehicle, and has a function as a reflection-transmission unit that reflects the radiation light L having struck from the free-form surface mirror 30 in the direction of the viewpoint by a surface inside the vehicle, and transmits light from an outside of the vehicle in the direction of the viewpoint. While the example in which the windshield 60 is used as the reflection-transmission unit is shown here, a combiner may be prepared as a reflection-transmission unit separately from the windshield 60 to reflect the light from the free-form surface mirror 30 in the viewpoint direction. The reflection-transmission unit is not limited to one that is located on the front side of the vehicle, and may instead be disposed on a lateral side or a rear side as long as an image is projected relative to the viewpoint of an occupant. The viewpoint is an eye (eyebox) of the driver or the occupant of the vehicle, and the driver or the occupant views a formed virtual image as the radiation light strikes the eyebox and the light reaches the retina.

The virtual image is displayed as if it were formed in space when the radiation light reflected by the windshield 60 reaches the viewpoint (eyebox) of the driver etc. The position at which the virtual image is formed is determined by an angle of spread with which the light radiated from the image radiation unit 10 travels in the viewpoint direction after being reflected by the free-form surface mirrors 20, 30 and the windshield 60. In this case, the driver or the occupant perceives the virtual image as if it were present at an image formation position farther away than the windshield 60. Here, the image formation position of the virtual image depends mainly on a composite focal distance of the free-form surface mirror 20 and the free-form surface mirror 30. Even though the windshield 60 is not a flat surface but has a curved surface shape, the radius of curvature thereof is large compared with those of the free-form surface mirror 20 and the free-form surface mirror 30, and therefore the influence of optical power due to the windshield 60 is negligible.

FIG. 4 is a graph showing a relationship between the incidence angle and the reflectance in the angle-dependent light transmission unit 40. The axis of abscissa of the graph represents an angle inclined from 0 degrees as the incidence angle, with a direction perpendicular to a surface of the angle-dependent light transmission unit 40 being 0 degrees. The axis of ordinate of the graph represents the reflectance of the angle-dependent light transmission unit 40 for polarized light (P-polarized light) in in-plane directions including a 0-degree direction and an incidence direction of light. As shown in FIG. 4, the angle-dependent light transmission unit 40 has optical characteristics that the reflectance is low (the transmittance is high) for light that has a small incidence angle and has struck nearly in a perpendicular direction; that the reflectance increases (the transmittance decreases) as the incidence angle increases; and that the reflectance is close to 100% when the incidence angle is equal to or larger than a predetermined incidence angle.

As the angle-dependent light transmission unit 40 having the optical characteristics as shown in FIG. 4, a laminate film (product name “PICASUS (R) VT”) manufactured by Toray Industries, Inc. or the laminate film described in Japanese Unexamined Patent Application Publication No. 2021-54061 (JP 2021-54061 A) can be used. While the example in which the reflectance reaches a maximum value of 100% when the incidence angle is approximately 40 degrees is shown in the example shown in FIG. 4, the reflectance of the maximum value and the incidence angle at which the maximum value is reached are not limited thereto.

As shown in FIG. 1 to FIG. 3, the angle-dependent light transmission unit 40 is formed in a film form of a substantially flat plate shape, and is held while being bent in at least one axis direction. Here, the bending direction of the angle-dependent light transmission unit 40 corresponds to P-polarized light relative to the windshield 60. The optical characteristics of the angle-dependent light transmission unit 40 shown in FIG. 4 are those for polarized light (P-polarized light) in the bending direction of the angle-dependent light transmission unit 40.

As shown in FIG. 1, since the external light Ls, such as sunlight, strikes from above the windshield 60, also within the range of the light cone formed by the radiation light L, the external light Ls travels in the opposite direction toward the image radiation unit 10 at an angle different from the optical path of the radiation light L. The transmission axis direction of the polarized light selection unit 50 corresponds to the bending direction of the angle-dependent light transmission unit 40, and the external light Ls having been transmitted through the polarized light selection unit 50 is only P-polarized light, which is subjected to the influence of the optical characteristics of the angle-dependent light transmission unit 40. Here, bending the angle-dependent light transmission unit 40 can increase the incidence angle of the external light Ls relative to the angle-dependent light transmission unit 40. Thus, the incidence angle of the radiation light L relative to the angle-dependent light transmission unit 40 becomes smaller than the incidence angle of the external light Ls, and since the angle-dependent light transmission unit 40 is bent in the direction of P-polarized light relative to the windshield 60, the radiation light L and the external light Ls are reflected (transmitted) at the reflectance of the reflectance characteristics shown in FIG. 4.

Therefore, by appropriately setting a radius of curvature r of the angle-dependent light transmission unit 40 and the inclination angle thereof relative to the optical path of the radiation light L, the reflectance for the radiation light L can be made lower and the reflectance for the external light Ls can be made higher. Thus, the radiation light L radiated from the image radiation unit 10 can be favorably transmitted through the angle-dependent light transmission unit 40 to be used to project a virtual image, while the external light Ls can be reflected by the angle-dependent light transmission unit 40 so as to reduce the amount of light that reaches the image radiation unit 10. As a result, a temperature rise of the image radiation unit 10 due to the external light Ls reaching it can be mitigated to prevent deterioration.

FIG. 4 shows an example in which the radiation light L strikes at an incidence angle within a range of around 15 degrees indicated by the solid-black bar chart and the external light Ls strikes at an incidence angle of about 35 degrees indicated by the outlined bar chart. In this example, the reflectance of the radiation light L is about 20%, and about 80% is transmitted. The reflectance of the external light Ls is about 80%, and only about 20% is transmitted. The incidence angles shown in FIG. 4 are one example, and it is preferable that the reflectance of the radiation light L be set to 30% or lower and that the reflectance of the external light Ls be set to 70% or higher. Therefore, it is preferable that the radius of curvature of the angle-dependent light transmission unit 40 be within a range of 10 mm to 1000 mm.

The radius of curvature r of the angle-dependent light transmission unit 40 being smaller than 10 mm is not preferable, because an aberration that occurs in the transmitted radiation light L due to a difference in refractive index between the angle-dependent light transmission unit 40 and air becomes large, which potentially results in degradation of the quality of the projected image. Further, the radius of curvature r being too small is not preferable, because the size of the image that can be projected by the image projection device 100 becomes small and increasing the size of the image requires increasing the size of a casing. On the other hand, when the radius of curvature of the angle-dependent light transmission unit 40 is larger than 1000 mm, it becomes difficult to produce a difference between the incidence angles of the radiation light L and the external light Ls, as well as it becomes difficult to reduce the size of the device. Therefore, when the radius of curvature r is within the range of 10 mm to 1000 mm, a difference of about 20 to 30 degrees can be provided between the incidence angles of the radiation light L and the external light Ls relative to the angle-dependent light transmission unit 40 to thereby secure a difference in reflectance.

Since the radiation light L that is reflected by the free-form surface mirror 30 toward the windshield 60 is almost parallel light, the free-form surface mirror 30 will be approximated to an elliptical shape for consideration. As shown in FIG. 1, the external light Ls strikes an end region of the free-form surface mirror 30, which results in a difference of about a few degrees (e.g., 2.5 degrees) from the optical path of the radiation light L that is reflected at a central region. To increase such a few-degree difference in optical path to a difference in incidence angle of about 20 to 30 degrees as described above, it is preferable that R≥r be met, with R being a value at which the radius of curvature of a curved surface forming the free-form surface mirror 30 becomes maximum.

Preferable optical characteristics of the angle-dependent light transmission unit 40 are that, when reflectances of a P-wave or an S-wave at incidence angles of 20 degrees, 40 degrees, and 70 degrees are R20, R40, and R70, respectively, R20<R40<R70 is met, with R70 being 30% or higher. When the relationship between the incidence angle and the reflectance meets these conditions, it is possible to favorably transmit the radiation light L and reflect the external light Ls.

It is preferable that the saturation of the angle-dependent light transmission unit 40 be 20 or lower. When the saturation meets this condition, the color of the radiation light L does not become degraded, and quality deterioration of the projected virtual image can be avoided.

It is preferable that the difference between a maximum value and a minimum value of the reflectance within a visible light range (450 to 650 nm) when light strikes at an incidence angle of 70 degrees be smaller than 40%. When the difference in reflectance within the visible light range meets these conditions, the reflectance for a wide wavelength range included in the external light Ls, such as sunlight, can be increased to thereby reduce the amount of light of the external light Ls that reaches the image radiation unit 10 and mitigate the temperature rise.

In the image projection device 100 of this embodiment, the radiation light L radiated from the image radiation unit 10 reaches the viewpoint via the free-form surface mirror 20, the angle-dependent light transmission unit 40, the free-form surface mirror 30, the polarized light selection unit 50, and the windshield 60. Thus, the driver or the occupant can view a background through the windshield 60 and the virtual image of the image projected from the image projection device 100 in a superimposed state. Of the external light Ls, only the P-polarized light is transmitted in the polarized light selection unit 50 and reflected by the free-form surface mirror 30 to reach the angle-dependent light transmission unit 40. Since the angle-dependent light transmission unit 40 has a high reflectance at the incidence angle of the external light Ls as described above, the intensity of the external light Ls that is transmitted through the angle-dependent light transmission unit 40 and reaches the image radiation unit 10 is reduced. Thus, deterioration of the image radiation unit 10 due to a temperature rise can be mitigated.

As has been described above, the image projection device 100 of this embodiment can transmit the radiation light L from the image radiation unit 10 while cutting off the external light Ls by the angle-dependent light transmission unit 40. Thus, a temperature rise of the image radiation unit 10 due to the external light Ls can be effectively mitigated while the quality of the projected image is maintained.

### Second Embodiment

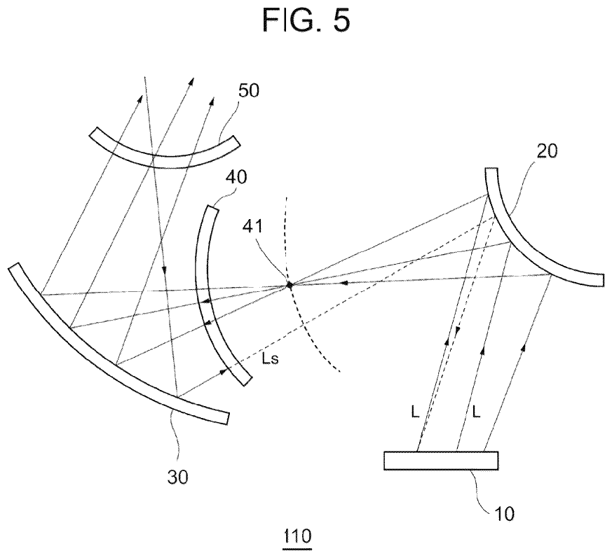

Next, a second embodiment of the present invention will be described using FIG. 5. Description of contents that overlap with the first embodiment will be omitted. FIG. 5 is a schematic view showing the configuration of an image projection device 110 according to this embodiment. As shown in FIG. 5, the image projection device 110 has the image radiation unit 10, the free-form surface mirrors 20, 30, the angle-dependent light transmission unit 40, and the polarized light selection unit 50.

Unlike in the first embodiment, the radiation light L reflected by the free-form surface mirror 20 is collected at a predetermined intermediate image formation position 41 located between the free-form surface mirror 20 and the free-form surface mirror 30, and is formed into an image at the intermediate image formation position 41 before reaching the free-form surface mirror 30. Thus, the free-form surface mirror 20 in this embodiment is equivalent to an intermediate image formation optical unit in the present invention. The angle-dependent light transmission unit 40 is disposed in the optical path of the radiation light L between the free-form surface mirror 20 and the free-form surface mirror 30, at a position closer to the windshield 60 than the intermediate image formation position 41. Therefore, the radiation light L is transmitted through the angle-dependent light transmission unit 40 while increasing in light diameter after being collected at the intermediate image formation position 41.

The image projection device 110 of this embodiment can also transmit the radiation light L from the image radiation unit 10 while cutting off the external light Ls by the angle-dependent light transmission unit 40. Thus, a temperature rise of the image radiation unit 10 due to the external light Ls can be effectively mitigated while the quality of the projected image is maintained. Moreover, since the radiation light L is collected at the intermediate image formation position 41 and the angle-dependent light transmission unit 40 is disposed at the intermediate image formation position 41, the area of the angle-dependent light transmission unit 40 can be reduced to achieve reductions in size and weight of the device.

### Third Embodiment

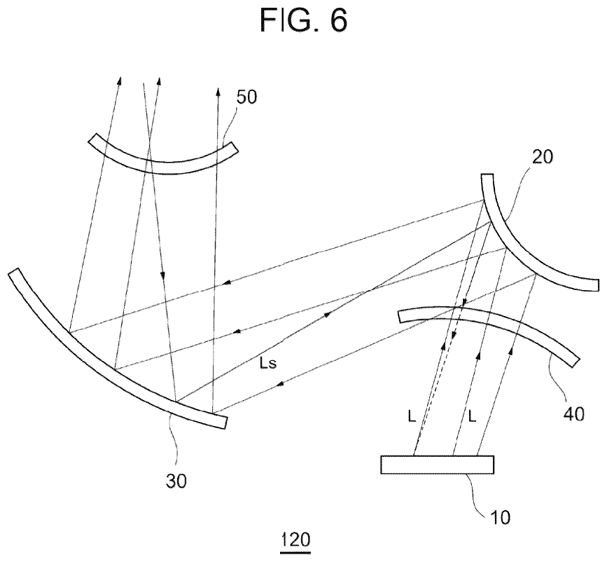

Next, a third embodiment of the present invention will be described using FIG. 6. Description of contents that overlap with the first embodiment will be omitted. FIG. 6 is a schematic view showing the configuration of an image projection device 120 according to this embodiment. As shown in FIG. 6, the image projection device 120 has the image radiation unit 10, the free-form surface mirrors 20, 30, the angle-dependent light transmission unit 40, and the polarized light selection unit 50. Unlike in the first embodiment, the angle-dependent light transmission unit 40 is disposed between the image radiation unit 10 and the free-form surface mirror 20.

Also in the image projection device 120 of this embodiment, since the angle-dependent light transmission unit 40 is disposed, it is possible to mitigate a temperature rise of the image radiation unit 10 by cutting off the external light Ls while favorably transmitting the radiation light L and projecting an image. Moreover, since the angle-dependent light transmission unit 40 is provided at a position close to the image radiation unit 10, the area of the angle-dependent light transmission unit 40 can be set to a minimum required area to save space. In addition, the optical path of the radiation light L can be sufficiently secured between the free-form surface mirror 20 and the free-form surface mirror 30, which can increase the degree of freedom in the design.

### Fourth Embodiment

Next, a fourth embodiment of the present invention will be described. While the example in which the angle of the angle-dependent light transmission unit 40 relative to the optical path of the radiation light L is fixed is shown in the first embodiment to the third embodiment, an angle changing unit that mechanically changes the angle of the angle-dependent light transmission unit 40 may be included. The specific configuration of the angle changing unit is not limited; one example is a configuration in which an outer peripheral part of the angle-dependent light transmission unit 40 is held by a holding tool and the position of the holding tool is changed using a motive power source that is separately provided.

In the first embodiment to the third embodiment, the example has been shown in which an image of the radiation light L is formed on the side of the image radiation unit 10 relative to the windshield 60 so as to form a virtual image farther away than the windshield 60 by a projection optical system composed of the free-form surface mirrors 20, 30. However, the image formation position of the projected image is not limited, and an image of the radiation light L may be formed between the windshield 60 and the viewpoint so as to project a real image on a side closer to the viewpoint relative to the windshield 60 by the projection optical system composed of the free-form surface mirrors 20, 30.

The present invention is not limited to each of the above-described embodiments, and various changes can be made within the scope indicated in the claims. Embodiments that are obtained by appropriately combining the technical solutions respectively disclosed in different embodiments are also included in the technical scope of the present invention.

This international application claims priority based on Japanese Patent Application No. 2021-189004 that is a Japanese patent application filed on Nov. 19, 2021, and the entire contents of Japanese Patent Application No. 2021-189004 that is a Japanese patent application are incorporated in this international application.

The description given above about the specific embodiments of the present invention has been presented for illustrative purposes. They are not intended to be comprehensive or restrict the present invention to the described forms as they are. It is obvious to those skilled in the art that numerous modifications and changes are possible in light of the contents of the above description.

### REFERENCE SIGNS LIST

100, 110, 120: Image projection device
10: Image radiation unit
20, 30: Free-form surface mirror
40: Angle-dependent light transmission unit
41: Intermediate image formation position
50: Polarized light selection unit
60: Windshield

1. An image projection device comprising:
an image radiation unit configured to radiate an image;
a reflection-transmission unit configured to reflect radiation light from the image radiation unit at a front surface and transmits light from a back surface; and
an angle-dependent light transmission unit of which transmittance of light in a predetermined polarization plane changes depending on an incidence angle, wherein
the angle-dependent light transmission unit is disposed in an optical path of the radiation light from the image radiation unit to the reflection-transmission unit.

2. The image projection device according to claim 1, further comprising:
an angle changing unit configured to change an angle of the angle-dependent light transmission unit relative to the optical path.

3. The image projection device according to claim 1, wherein the angle-dependent light transmission unit is held while being bent in at least one axis direction.

4. The image projection device according to claim 3, wherein a radius of curvature of the angle-dependent light transmission unit is within a range of 10 mm to 1000 mm.

5. The image projection device according to claim 1, further comprising:
a polarized light selection unit configured to transmit polarized light in a transmission axis direction and blocks polarized light orthogonal to the transmission axis direction, wherein the polarized light selection unit is disposed in the optical path from the angle-dependent light transmission unit to the reflection-transmission unit.

6. The image projection device according to claim 5, wherein the transmission axis direction of the polarized light selection unit corresponds to the predetermined polarization plane.

7. The image projection device according to claim 1, further comprising:
an intermediate image formation optical unit that is disposed in the optical path from the image radiation unit to the reflection-transmission unit and configured to form an image of light from the image radiation unit at an intermediate image formation position.

8. The image projection device according to claim 7, wherein the angle-dependent light transmission unit is disposed in the optical path of the radiation light, at a position closer to the reflection-transmission unit than the intermediate image formation position.
